(19) United States
(12) Patent Application Publication
(10) Pub. No.: US 2012/0184218 A1
(43) Pub. Date: Jul. 19, 2012

(54) Reduced Bandwidth Backhaul for Coordinated Multi-Point Reception

(75) Inventors: Gary David Boudreau, Kanata (CA); Adrien Joseph Comeau, Ottawa (CA)

(73) Assignee: Telefonaktiebolaget L M Ericsson (publ), Stockholm (SE)

(21) Appl. No.: 13/005,632

(22) Filed: Jan. 13, 2011

(51) Int. Cl. H04W 28/16; H04W 88/02

(52) U.S. Cl. 455/63.1; 455/39

(57) ABSTRACT

Embodiments herein provide reduced backhaul bandwidth requirements for Coordinated Multi-Point reception of an uplink signal. A cooperating base station receive and demodulates the uplink signal to produce soft output values that each indicate the value of a corresponding information symbol in the uplink signal and the level of certainty in that symbol value. The cooperating base station then selectively sends particular ones of the soft output values to a serving base station over a backhaul communication link based on whether or not the level of certainty indicated by each soft output value exceeds a certainty threshold. The serving base station likewise receives and demodulates the uplink signal to produce its own soft output values. The serving base station then combines respective ones of the soft output values it received from the cooperating base station and the soft output values it produced itself that are associated with the same information symbol.

### TECHNICAL FIELD

The present invention relates generally to coordinated multipoint (CoMP) reception of an uplink signal in a wireless communication network and, more particularly, to methods and apparatus that reduce the backhaul bandwidth required for CoMP reception.

### BACKGROUND

The phenomenal growth in the demand for wireless communications has put persistent pressure on wireless network operators to improve the capacity of their communication networks. To improve the spectral efficiency of these networks, scarce radio resources have to be reused aggressively in neighboring cells. As a result, inter-cell interference has become a main source of signal disturbance, limiting not only the service quality to users at the cell edges, but also the overall system throughput.

Coordinated Multi-Point (CoMP) reception in the uplink is one technique being considered for mitigating inter-cell interference in International Mobile Telecommunications (IMT) Advanced systems. CoMP reception differs from reception in a conventional system in that uplink signals are received at multiple, geographically dispersed base stations, and then sent across backhaul communication links to a common location for joint processing (e.g., to the serving base station). In effect, this architecture forms a “super-cell,” called a CoMP cell, where uplink signals that would have been treated by a conventional cell as inter-cell interference are instead treated by the CoMP cell as desired signals. The mitigation in inter-cell interference is expected to significantly improve system performance, especially for users near the edge of a conventional cell.

Sending the received uplink signals across backhaul communication links, however, would require significant and potentially prohibitive backhaul bandwidth. Sending raw samples of the received uplink signals, for example, could necessitate a peak data rate on the order of 20 Gpbs. Such an enormous peak rate would be excessively complex and expensive to implement, and would in any event be unsustainable over any significant amount of time.

### SUMMARY

Methods and apparatus provide reduced backhaul bandwidth requirements for Coordinated Multi-Point (CoMP) reception of an uplink signal, by sending soft output values, instead of raw samples of the uplink signal, over a backhaul communication link. In some embodiments, only those soft output values that have a relatively high certainty are sent. Because the unsent soft output values with relatively low certainty provide little performance benefits to CoMP reception of the uplink signal, backhaul bandwidth requirements are reduced while maintaining substantially the same CoMP reception performance.

More particularly, a cooperating base station according to some embodiments herein includes one or more receive antennas, a demodulator, and an inter-base station communication interface. The one or more receive antennas receive an uplink signal transmitted by a mobile terminal. The demodulator demodulates the uplink signal to produce soft output values. Each of these soft output values indicates the value of a corresponding information symbol in the uplink signal and the level of certainty in that symbol value. In at least one embodiment, soft output values comprise log-likelihood ratios (LLRs). The inter-base station communication interface selectively sends particular ones of the soft output values to a serving base station over a backhaul communication link based on whether or not the level of certainty indicated by each soft output value exceeds a certainty threshold. Such selective sending effectively reduces backhaul bandwidth requirements.

Correspondingly, a serving base station according to various embodiments herein includes one or more receive antennas, a demodulator, an inter-base station communication interface, and a combining circuit. The one or more receive antennas receive the uplink signal transmitted by the mobile terminal, and the demodulator demodulates the uplink signal to produce soft output values. The inter-base station communication interface receives the soft output values from the cooperating base station over the backhaul communication interface. As noted above, each of these soft output values have been selected by the cooperating base station as indicating the value of a corresponding information symbol in the uplink signal with a level of certainty that exceeds a certainty threshold. Finally, the combining circuit combines respective ones of the produced soft output values and the received soft output values that are associated with the same information symbol.

Some embodiments statically set or dynamically adapt the above described certainty threshold to provide timely delivery of as many soft output values from the cooperating base station to the serving base station as possible while avoiding congestion on the backhaul communication link. If the backhaul communication link has congestion above a first congestion threshold, for example, the certainty threshold is dynamically increased in order to decrease the number of soft output values that must be sent and thereby reduce congestion. Likewise if the backhaul communication link has congestion below a second congestion threshold, the certainty threshold is dynamically decreased in order to increase the number of soft output values selectively sent and thereby improve decoding performance.

In embodiments where a serving base station receives different soft output values from different cooperating base stations over different backhaul communication links, the different certainty thresholds may be set independently of one another or set jointly. A serving base station that sets different certainty thresholds jointly, for example, may statically set the thresholds based on a combined capacity of the backhaul communication links incoming to the base station. Alternatively, a serving base station may request that at least one cooperating base station dynamically adapt the certainty threshold specific thereto responsive to receiving notice that another cooperating base station has dynamically adapted the certainty threshold specific thereto.

In at least one embodiment, a cooperating base station sends a serving base station indexing information that assists the serving base station with determining which soft output values were sent and which soft output values were not sent. In some embodiments, for example, a cooperating base station sends indexing information that identifies the location in time and frequency of the sent soft output values. With this indexing information, the serving base station identifies which of the soft output values it produced itself have the same location in time and frequency as the received soft output values. The serving base station then combines respective ones of the produced soft output values and the received soft output values that, according to the indexing information, have the same location in time and frequency.

To reduce the overhead from this indexing information, a cooperating base station in some embodiments sends indexing information that identifies the location of blocked groups of sent soft output values. Each blocked group includes a plurality of sent soft output values that are contiguously located in time and frequency. The serving base station receives this indexing information and identifies the general location of received soft output values on a block-by-block basis. Then, the serving base station identifies the particular location of received soft output values within any given time-frequency block according to a pre-determined filling scheme.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a Coordinated Multi-Point (CoMP) system including a serving base station and one or more cooperating base stations according to one or more embodiments.

FIG. 2 is a logic flow diagram of a method implemented by a cooperating base station for CoMP reception of an uplink signal according to some embodiments.

FIG. 3 is a logic flow diagram of a method implemented by a serving base station for CoMP reception of an uplink signal according to some embodiments.

FIGS. 4A-4B are block diagrams describing indexing information sent from a cooperating base station to a serving base station according to at least one embodiment.

FIG. 5 is a block diagram of a cooperating base station and a serving base station for CoMP reception of an uplink signal according to one or more embodiments.

### DETAILED DESCRIPTION

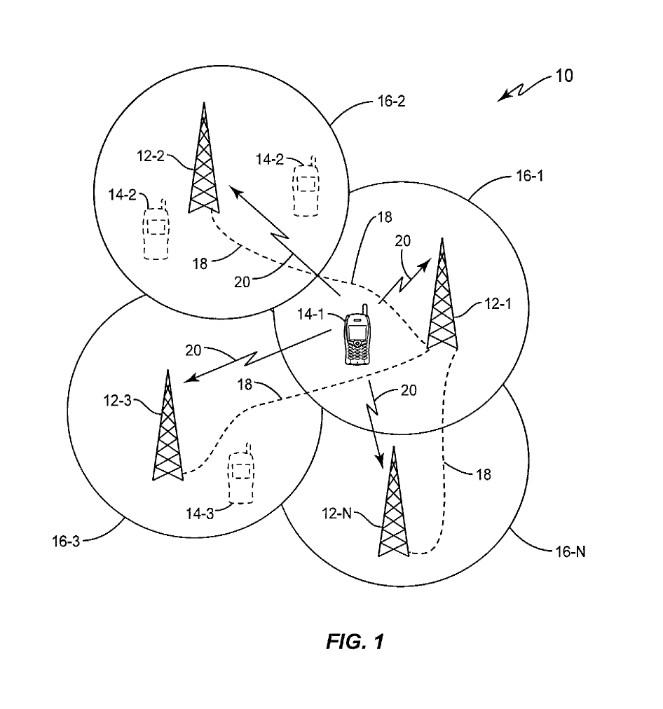

FIG. 1 illustrates one embodiment of a Coordinated Multi-Point (CoMP) system 10 that includes a plurality of geographically dispersed base stations 12-n, for n=1 . . . N. Each base station 12-n provides signal coverage for (i.e., serves) mobile terminals 14-n located within a corresponding geographic area 16-n referred to as a cell. In doing so, each base station 12-n receives uplink signals from those mobile terminals 14-n and processes (e.g., decodes) the uplink signals to recover information symbols therein.

A base station 12-n serving certain mobile terminals 14-n may nonetheless also receive uplink signals from other mobile terminals 14-m located within another cell 16-m (where m≠n). Rather than simply treating such uplink signals as inter-cell interference, the base station 12-n cooperates with the mobile terminals' serving base station 12-m. In particular, the base station 12-n sends the uplink signals to the mobile terminals' serving base station 12-m over a backhaul communication link 18 between the base stations 12. The mobile terminals' serving base station 12-m then jointly processes the uplink signals it received itself and the uplink signals received from other base stations 12 in order to mitigate inter-cell interference.

Any given base station 12-n therefore operates as a serving base station with respect to mobile terminals 14-n located within its served cell 16-n, while operating as a so-called cooperating base station with respect to mobile terminals 14-m located within another cell 16-m. Likewise from the perspective of any given mobile terminal 14-n, one base station 12-n operates as the serving base station for the terminal and other base stations 12-m operate as cooperating base stations for that terminal.

FIG. 1 depicts a simplified view of the CoMP system 10 from the particular perspective of a mobile terminal 14-1 located within cell 16-1. Base station 12-1 operates as the serving base station for mobile terminal 14-1. One or more other base stations 12-m, for m=2 . . . N, operate as cooperating base stations for that mobile terminal 14-1. These cooperating base stations 12-m each receive an uplink signal 20 transmitted by mobile terminal 14-1 and send that uplink signal 20 over respective backhaul communication links 18 to the serving base station 12-1 for joint processing.

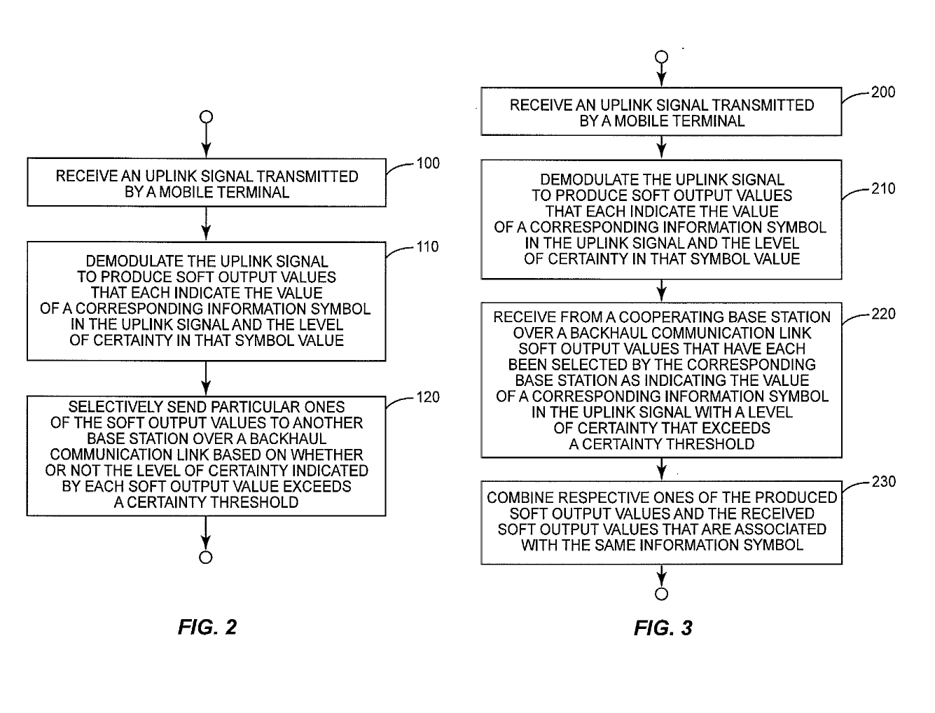

Notably, the cooperating base stations 12-m send the uplink signal 20 in a way that advantageously reduces the bandwidth requirements for the backhaul communication links 18, as compared to approaches that simply send raw samples of the uplink signal 20. In this regard, FIG. 2 illustrates processing implemented by a given cooperating base station 12-m (e.g., cooperating base station 12-2).

In FIG. 2, processing at cooperating base station 12-2 includes receiving an uplink signal 20 transmitted by mobile terminal 14-1 (Block 100). Processing further includes demodulating the uplink signal 20 to produce soft output values (Block 110). These soft output values each indicate the value of a corresponding information symbol in the uplink signal 20, as well as the level of certainty in that symbol value. In some embodiments, for example, such processing entails demodulating the uplink signal 20 to produce log-likelihood ratios (LLRs) for the information symbols in the uplink signal 20. Regardless, processing finally includes selectively sending particular ones of the soft output values to the serving base station 12-1 over a backhaul communication link 18 based on whether or not the level of certainty indicated by each soft output value exceeds a certainty threshold (Block 120).

In one or more embodiments, selective sending of particular soft output values entails sending a soft output value if the certainty indicated by that value exceeds the certainty threshold, but otherwise suppressing sending of that soft output value. Consequently, the cooperating base station 12-2 only sends those soft output values that have a high certainty relative to the certainty threshold. By only sending selected ones of the soft output values over a backhaul communication link 18, the cooperating base station 12-2 thereby reduces backhaul bandwidth requirements (e.g., to only 1 Gbps as opposed to the 20 Gbps required for sending raw samples). Moreover, appropriate setting of the certainty threshold (as explained in greater detail below) permits the cooperating base station 12-2 to reduce backhaul bandwidth requirements while at the same time maintaining substantially the same CoMP reception performance.

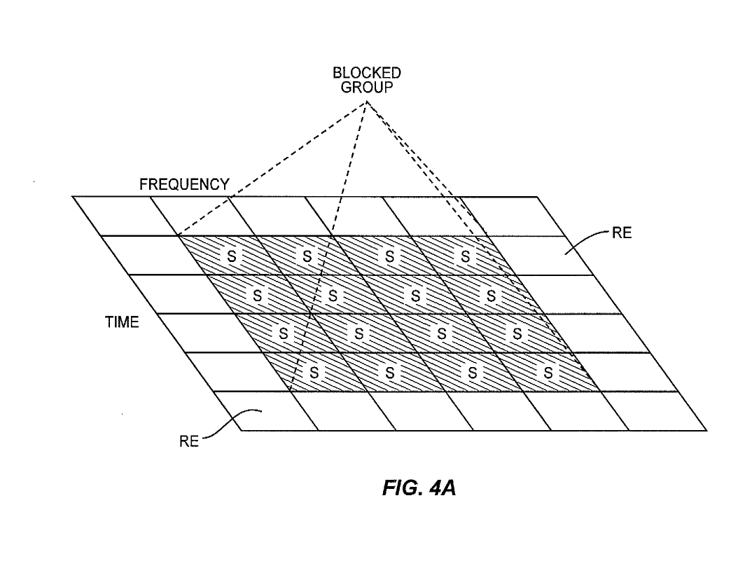

FIG. 3 illustrates corresponding processing implemented at the serving base station 12-1 in conjunction with (i.e., in parallel with) the cooperating base station processing described above in FIG. 2. In FIG. 3, processing at the serving base station 12-1 includes receiving the uplink signal 20 transmitted by mobile terminal 14-1 (Block 200). Processing at the serving base station 12-1 also includes demodulating the uplink signal 20 to produce soft output values (Block 210). These soft output values produced at the serving base station 12-1 each indicate the value of a corresponding information symbol in the uplink signal 20 and the level of certainty in that symbol value.

Processing at the serving base station 12-1 further includes receiving soft output values from cooperating base station 12-2 over the backhaul communication link 18 (Block 220). As described with respect to FIG. 2, the soft output values received at the serving base station 12-1 have each been selected by the cooperating base station 12-2 as indicating the value of a corresponding information symbol in the uplink signal 20 with a level of certainty that exceeds a certainty threshold. Having received these soft output values, processing finally includes combining respective ones of the produced soft output values and the received soft output values that are associated with the same information symbol (Block 230).

In some embodiments, for example, combining a produced soft output value and a received soft output value associated with the same information symbol entails averaging those soft output values to generate a combined soft output value for that symbol. In other embodiments, combining entails adding the soft output values together to generate the combined soft output value.

Of course, the serving base station 12-1 may not necessarily generate a combined soft output value for every information symbol in the uplink signal 20. Indeed, at least with respect to cooperating base station 12-2, the serving base station 12-1 only receives soft output values that have a certainty exceeding the certainty threshold of that cooperating base station 12-2. Therefore, if the serving base station 12-1 does not receive a soft output value for a given information symbol from cooperating base station 12-2, the serving base station 12-1 may have only the individual soft output value that it produced itself.

Accordingly, processing at the serving base station 12-1 in one or more embodiments generates a sequence of soft output values corresponding to the information symbols in the uplink signal 20, with some of those soft output values comprising combined values and others comprising individual values. Processing at the serving base station 12-1 may then include generating a corresponding sequence of hard output values based on decoding this sequence of soft output values, e.g., using a soft output decoding algorithm such as a soft output Viterbi algorithm (SOVA).

Soft output values received from the cooperating base station 12-2 for generation of combined values at the serving base station 12-1 improve the performance of such decoding. Nonetheless, soft output values with relatively lower certainty yield lower decoding performance improvements. Selective sending of only those soft output values with relatively higher certainty therefore reduces backhaul bandwidth requirements while maintaining substantially the same decoding performance. In this regard, the certainty threshold on which selective sending of the soft output values is based may in one or more embodiments be predetermined as the threshold providing defined backhaul bandwidth and decoding performance requirements.

Yet even if soft output values from the cooperating base station 12-2 have relatively high certainty, those values may not actually improve decoding performance if they are not received at the serving base station 12-1 in time for decoding. One factor threatening timely receipt of soft output values at the serving base station 12-1 is congestion on the backhaul communication link 18. Such congestion would occur if more soft output values exceed the certainty threshold than can be timely delivered to the serving base station 12-1. Various embodiments therefore statically set or dynamically adapt the certainty threshold to provide timely delivery of as many soft output values from the cooperating base station 12-2 to the serving base station 12-1 as possible while avoiding congestion.

In some embodiments, for example, the serving base station 12-1 statically sets the certainty threshold for the cooperating base station 12-2 based on the expected number of soft output values that will exceed that threshold and the total capacity of the backhaul communication link 18. In other embodiments, the cooperating base station 12-2 statically sets its own certainty threshold in this way.

In still other embodiments, either the serving base station 12-1 or the cooperating base station 12-2 dynamically adapts the certainty threshold based on the current congestion of the backhaul communication link 18. If the backhaul communication link 18 has congestion above a first congestion threshold, for example, the certainty threshold is dynamically increased in order to decrease the number of soft output values that must be sent and thereby reduce congestion. Likewise if the backhaul communication link 18 has congestion below a second congestion threshold, the certainty threshold is dynamically decreased in order to increase the number of soft output values selectively sent and thereby improve decoding performance.

Many of the above embodiments have been described with respect to the serving base station 12-1 and a single cooperating base station 12-2, purely for convenience. The embodiments may nonetheless actually involve more than just one cooperating base station 12-2. That is, each of a plurality of cooperating base stations 12-m may receive the uplink signal 20 from the mobile terminal 14-1 and separately perform the above processing for selective sending of soft output values to the serving base station 12-1 over a respective backhaul communication link 18. The serving base station 12-1 may thereby receive different soft output values from different cooperating base stations 12-m over different backhaul communication links 18. The serving base station 12-1 may then combine respective ones of the soft output values actually produced at the serving base station 12-1 and the soft output values received from the various cooperating base stations 12-m that are associated with the same information symbol.

In this context, different certainty thresholds may govern different cooperating base stations' selective sending of soft output values to the serving base station 12-1. In some embodiments, the different certainty thresholds are statically or dynamically set as described above, independently of one another. In other embodiments, though, the different certainty thresholds are set jointly, whereby setting of one certainty threshold directly or indirectly affects setting of another certainty threshold.

For example, in one or more embodiments, the serving base station 12-1 authoritatively directs the setting of the different certainty thresholds. The serving base station 12-1 may, for instance, send a command to each cooperating base station 12-m directing the setting of the certainty threshold specific to that base station 12-m. Upon receiving such command, a cooperating base station 12-m must set the certainty threshold as directed. With setting of the different certainty thresholds centralized at the serving base station 12-1, the base station 12-1 may jointly set those certainty thresholds. In some embodiments, the serving base station 12-1 jointly sets the certainty thresholds based on a combined capacity of the backhaul communication links 18 incoming to the base station 12-1.

In one or more other embodiments, each cooperating base station 12-m autonomously sets the certainty threshold specific to it. However, the serving base station 12-1 still coordinates joint setting of the different certainty thresholds among the cooperating base stations 12-m. In this regard, a cooperating base station 12-m that dynamically adapts the certainty threshold specific thereto (e.g., based on congestion of the backhaul communication link 18) notifies the serving base station 12-1 of that adaptation. Responsive to receiving this notification, the serving base station 12-1 requests that at least one other cooperating base station 12-m dynamically adapt the certainty threshold specific to that base station 12-m. A cooperating base station 12-m receiving such a request may, but is not required to, comply with the request.

Consider a specific example. Cooperating base station 12-2 experiences congestion on its backhaul communication link 18 to the serving base station 12-1 and dynamically increases the certainty threshold specific to that base station 12-2. This reduces the congestion, but decreases the number of soft output values that the serving base station 12-1 receives from cooperating base station 12-2 and correspondingly threatens to decrease decoding performance. Accordingly, cooperating base station 12-2 notifies the serving base station 12-1 of the decrease. Responsive to receiving the notification, the serving base station 12-1 requests that cooperating base station 12-3 dynamically decrease the certainty threshold specific to that base station 12-3. If cooperating base station 12-3 is not experiencing congestion, it decides to comply with the serving base station's request, decrease the certainty threshold, and thereby increase the number of soft output values that the serving base station 12-1 receives from it. This operates to offset any decrease in decoding performance that would have otherwise resulted from congestion experienced by cooperating base station 12-2.

Any given cooperating base station 12-m (e.g., base station 12-2) may also affect decoding performance in other ways, without regard to other cooperating base stations 12-m. The cooperating base station 12-2, for example, may suppress interference in the uplink signal 20 and thereby improve the level of certainty of soft output values sent to the serving base station 12-1. More particularly, cooperating base station 12-2 in some embodiments receives a composite signal. This composite signal not only includes the uplink signal 20 transmitted by mobile terminal 14-1, but also includes one or more interfering uplink signals transmitted by one or more other mobile terminals 14-2 and/or 14-3.

To increase the level of certainty of soft output values, the cooperating base station 12-2 suppresses interference in the uplink signal 20 received from mobile terminal 14-1 that is attributable to interfering uplink signals received from other mobile terminals 14-2 and/or 14-3. In various embodiments, cooperating base station 12-2 suppresses this interference by performing successive interference cancellation (SIC) to remove interference attributable to the mobile terminals 14-2 actually served by that base station 12-2. That is, the cooperating base station 12-2 decodes the uplink signals received from mobile terminals 14-2, re-encodes those uplink signals, and subtracts them from the composite signal. This effectively removes interference in the uplink signal 20 attributable to mobile terminals 14-2. With that interference removed, the cooperating base station 12-2 demodulates the uplink signal 20 to produce soft output values with greater levels of certainty than otherwise possible. Performing SIC at the cooperating base station 12-2 adds some required processing at that base station 12-2, but lessens the processing otherwise required at the serving base station 12-1. Note that the processing added at the cooperating base station 12-2 is only attributable to the actual SIC processing, not to the decoding required as a pre-requisite to that SIC processing; indeed, the base station 12-2 must decode the uplink signals received from the mobile terminals 14-2 it serves anyway.

The above embodiment illustrates the interdependency between the interference in the uplink signal 20 and the levels of certainty of the soft output values produced at the cooperating base station 12-2. In this regard, the cooperating base station 12-2 may base selective sending of soft output values on any number of measures that directly or indirectly reflect the level of certainty of those soft output values.

In one embodiment, of course, the cooperating base station 12-2 bases selective sending of soft output values directly on the actual magnitude of those soft output values. In cases where soft output values are LLRs, for instance, the magnitude of soft output values directly indicates the level of certainty of those soft output values. In another embodiment, though, the cooperating base station 12-2 instead bases selective sending of soft output values on the signal-to-interference-plus-noise ratio (SINR) of the uplink signal 20, which indirectly reflects the level of certainty of the soft output values produced.

Regardless of the actual measure on which the cooperating base station 12-2 bases selective sending of soft output values, the base station 12-2 only sends particular ones of those soft output values. Correspondingly, the serving base station 12-1 only receives particular ones of the soft output values from the cooperating base station 12-2. The serving base station 12-1 must therefore determine which soft output values were sent and which soft output values were not sent, in order to combine the received soft output values with corresponding soft output values produced by the serving base station 12-1 itself. In some embodiments, the cooperating base station 12-2 sends indexing information along with the soft output values that assists the serving base station 12-1 in this determination.

For example, the mobile terminal 14-1 in one or more embodiments transmits information symbols of the uplink signal 20 in certain time-frequency resources defined on an uplink communication channel. The cooperating base station 12-2 demodulates the uplink signal 20 to produce soft output values that each indicate the value of a corresponding information symbol in the uplink signal 20. The cooperating base station 12-2 then selectively sends particular ones of those soft output values to the serving base station 12-1 as a sequence of soft output values. The cooperating base station 12-2 also sends indexing information that identifies the location in time and frequency of the sent soft output values. With this indexing information, the serving base station 12-1 identifies which of the soft output values it produced itself have the same location in time and frequency as the received soft output values. The serving base station 12-1 then combines respective ones of the produced soft output values and the received soft output values that, according to the indexing information, have the same location in time and frequency.

In some contexts, this indexing information could add significant overhead, which would threaten to offset the reduction in backhaul bandwidth requirements otherwise achieved from selective sending of soft output values. Consider, for example, embodiments where the CoMP system 10 comprises a Long Term Evolution (LIE) or LTE-Advanced system.

At the transport channel level, the mobile terminal 14-1 transmits the uplink signal 20 over an Uplink Shared Channel (UL-SCH). During any given transmission time interval, the mobile terminal 14 transmits one transport block over the UL-SCH. At the physical channel level, the mobile terminal 14-1 is scheduled to transmit information symbols for this transport block over a Physical Uplink Shared Channel (PUSCH). Specifically, the mobile terminal 14-1 is scheduled to transmit the information symbols over certain resource blocks (RBs) defined on the PUSCH, where RBs are scheduled in time-wise pairs. Each RB includes 84 individual time-frequency resources (7 across time and 12 across frequency) referred to as resource elements (REs), within which a single information symbol is transmitted. Each RB pair therefore theoretically includes 168 REs (14 across time and 12 across frequency) in which to transmit 168 information symbols (although, in practice, less than 168 symbols will be available for information due to the need to reserve some of the REs for reference and control symbols).

Assuming that the maximum size of a transport block transmitted by the mobile terminal 14-1 would require transmission across 25 RB pairs, the uplink signal 20 during any given transmission time interval would include 25 RB pairs*168 REs per RB pair=4200 REs=4200 information symbols. The cooperating base station 12-2 would selectively send soft output values for only some of those 4200 information symbols, which of course would reduce the backhaul bandwidth requirements as compared to sending raw samples or soft output values for all 4200. However, some of this reduction could be offset if the cooperating base station 12-2 were to also send indexing information that uniquely identified each soft output value with one of the 4200 REs. Indeed, in this case the indexing information would include one 13 bit index for every soft output value sent. If the soft output values are only 9 bits, the indexing information would add 140% overhead.

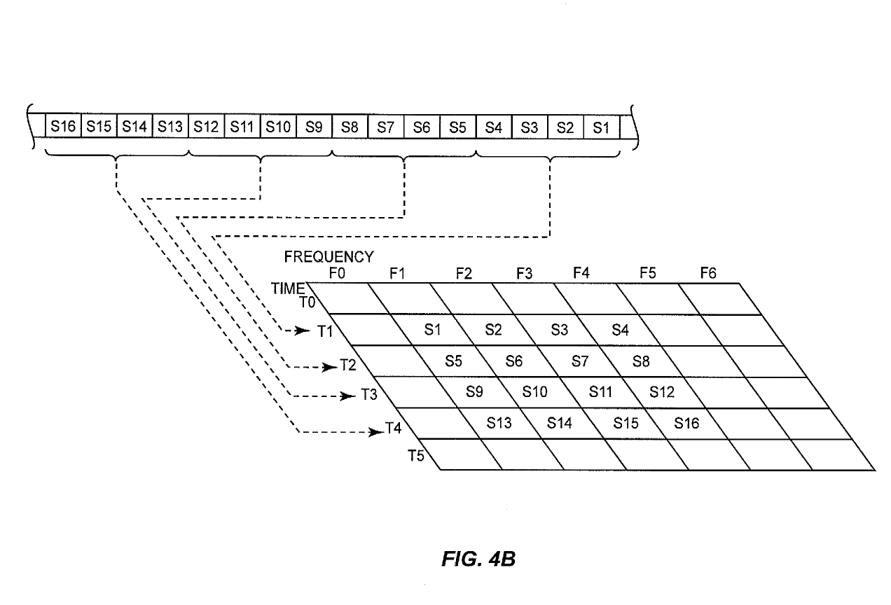

FIG. 4A illustrates one or more embodiments that advantageously reduce the overhead attributable to indexing information. These embodiments recognize that, often, soft output values with a relatively high level of certainty are grouped together, and soft output values with a relatively low level of certainty are grouped together. Thus, those soft output values that are selectively sent to the serving base station 12-1 because they indicate a level of certainty above a certainty threshold, will be located contiguously in time and frequency (i.e., in contiguous REs) as shown in FIG. 4A.

Accordingly, rather than sending indexing information that identifies the location of each sent soft output value on an individual basis, a cooperating base station 12-2 sends indexing information that identifies the location of blocked groups of sent soft output values. Each blocked group includes a plurality of sent soft output values that are contiguously located in time and frequency. The serving base station 12-1 receives this indexing information and identifies the general location of received soft output values on a time-frequency block-by-block basis. Then, within any given time-frequency block, the serving base station 12-1 identifies the particular location of received soft output values on a resource-by-resource basis according to a pre-determined filling scheme. FIG. 4B illustrates an example filling scheme for identifying the location of soft output values within a given time-frequency block.

In FIG. 4B, the serving base station 12-1 receives indexing information for a sequence of soft output values S1-S16. With this indexing information, the serving base station 12-1 identifies the general location of S1-S16 as being within a blocked group of time-frequency resources F1-F4×T1-T4. The indexing information, however, does not identify the specific location of each soft output value S1-S16 within that blocked group. Instead, the serving base station 12-1 identifies the particular location of each soft output value S1-S16 according to a pre-determined filling scheme. This scheme fills soft output values S1-S16 within the blocked group across frequency resources first, and then across time resources. In FIG. 4B, for example, the serving base station 12-1 fills the first four soft output values S1-S4 in the received sequence across frequency resources F1-F4, respectively, within the time resource T1. Next, the serving base station 12-1 fills the second four soft output values S5-S8 across frequency resources F1-F4, respectively, within the time resource T2. The serving base station 12-1 continues filling time-frequency resources in this way until the entire blocked group identified by the indexing information is filled.

Indexing information that identifies the location of soft output values in this way drastically reduces the overhead attributable to that information. In the LTE context, for example, a cooperating base station 12-2 need only send indexing information that identifies the location of a blocked group of REs. To do so, a cooperating base station 12-1 in some embodiments sends one so-called locator element for each blocked group. This locator element includes (1) a time index and frequency index that collectively identify a reference RE; and (2) a time length and a frequency length that collectively identify the bounds of the blocked group relative to the identified reference RE.

In FIG. 4B, for example, a locator element may include a time index T1 and a frequency index F1 that collectively identify the T1-F1 RE as the reference RE. The locator element may further include a time length of 4 and a frequency length of 4, that identify the bounds of the blocked group as extending 4 REs in time relative to the T1-F1 RE (i.e., from T1 to T4) and 4 REs in frequency relative to the T1-F1 RE (i.e., from F1 to F4).

Of course, FIG. 4B has been simplified for illustrative purposes. Blocked groups in practice may be much larger, perhaps as large as half of a RB pair (i.e., 84 REs). Under this assumption, and again assuming a maximum transport block size of 25 RB pairs, any given locator element for locating a blocked group need only be 24 bits. Half of these bits identify a reference RE for the blocked group (4 bits for identifying the reference RE in time and 8 bits for identifying the reference RE in frequency). The other half identify the bounds of the blocked group relative to that reference RE (4 bits for identifying the bounds in time and 8 bits for identifying the bounds in frequency). With one locator element of 24 bits being sent to identify the location of eighty-four 9-bit soft output values in a blocked group, the indexing information adds merely 3% overhead.

Those skilled in the art will of course appreciate that the above embodiments have been described with respect to a single mobile terminal 14-1 located within a single cell 16-1 merely for ease of illustration. CoMP reception as contemplated herein, though, is performed for each mobile terminal within that cell 16-1. Therefore, the cooperating base stations 12-m may receive uplink signals for each of a plurality of mobile terminals located within cell 16-1, and selectively send soft output values to serving base station 12-1 for each of those terminals. In this regard, selective sending may be based upon different certainty thresholds for different mobile terminals.

Moreover, those skilled in the art will understand that while FIG. 1 shows each base station 12 as providing signal coverage for (i.e., serving) only a single cell, a base station 12 may in fact provide signal coverage for one or more cells. In this case, a base station 12 may be located at the boundary between multiple cells, rather than in the center of a single cell. Accordingly, a cooperating base station 12-m may receive an uplink signal 20 at each of the one or more cells, and demodulate that uplink signal to produce different soft output values for each cell. The cooperating base station 12-m may then selectively send particular ones of the different soft output values based on whether or not the certainty indicated by each soft output value exceeds the same certainty threshold. That is, although the cooperating base station 12-m sends different soft output values for the different cells, the base station 12-m bases selective sending of those values on the same certainty threshold.

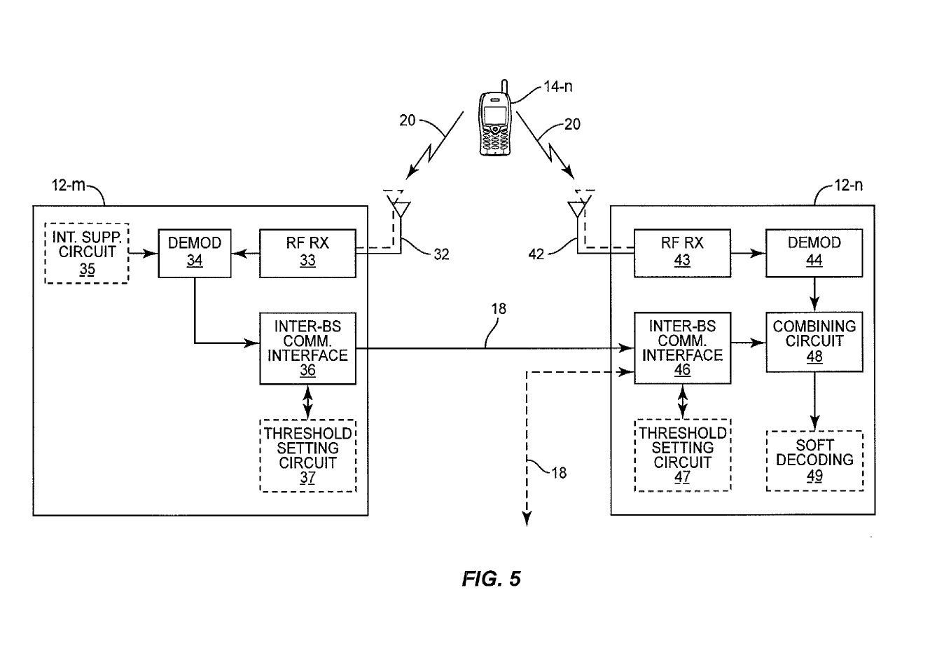

With the above variations and modifications in mind, those skilled in the art will appreciate that a cooperating base station 12-m and a serving base station 12-n are generally configured as shown in FIG. 5 for CoMP reception of an uplink signal 20 transmitted by a mobile terminal 14-n. In FIG. 5, a cooperating base station 12-m includes one or more receive antennas 32, a demodulator 34, and an inter-base station communication interface 36. The one or more receive antennas 32 are configured to receive the uplink signal 20 transmitted by the mobile terminal 12-n. The antenna(s) 32 provide this uplink signal 20 to the demodulator 34, e.g., via a radio frequency (RF) receiver (RX) 33.

The demodulator 34 is configured to demodulate the uplink signal 20 to produce soft output values that each indicate the value of a corresponding information symbol in the uplink signal 20 and the level of certainty indicated in that symbol value. In some embodiments, an interference suppression circuit 35 cooperates with the demodulator 34 to suppress interference in the uplink signal 20, for production of soft output values with greater certainty than otherwise possible.

Regardless, the inter-base station communication interface 36 is configured to selectively send particular ones of the soft output values produced by the demodulator 34 to the serving base station 12-n over a backhaul communication link 18. In doing so, the inter-base station communication interface 36 selectively sends the soft output values based on whether or not the level of certainty indicated by each soft output value exceeds a certainty threshold. In some embodiments, this certainty threshold is statically set or dynamically adapted as described above by a threshold setting circuit 37 of the cooperating base station 12-m.

The serving base station 12-n similarly includes one or more receive antennas 42, a demodulator 44, and an inter-base station communication interface 46. The one or more receive antennas 42 are configured to receive the uplink signal 20, and the demodulator 44 is configured to demodulate the uplink signal 20 to produce soft output values that each indicate the value of a corresponding information symbol in the uplink signal 20 and the level of certainty indicated in that symbol value. The inter-base station communication interface 46 is configured to receive from the cooperating base station 12-m over the backhaul communication link 18 the soft output values produced by that cooperating base station 12-m. As just described, these soft output values have each been selected by the cooperating base station 12-m as indicating the value of a corresponding information symbol in the uplink signal 20 with a level of certainty that exceeds a certainty threshold. The serving base station 12-n in some embodiments includes a threshold setting circuit 47 that statically sets or dynamically adapts that threshold as described above.

Finally, the serving base station 12-n also includes a combining circuit 48. The combining circuit 48 is configured to combine respective ones of the soft output values produced by the demodulator 44 and the soft output values received by the inter-base station communication interface 46 that are associated with the same information symbol. The combining circuit 48 may thereby generate a sequence of soft output values corresponding to the information symbols in the uplink signal 20, with some of those soft output values comprising combined values and others comprising individual values. The serving base station 12-n in at least one embodiment further includes a soft decoding circuit 49 configured to decode this sequence of soft output values in order to generate a corresponding sequence of hard output values.

Those skilled in the art will also appreciate that the various “circuits” described may refer to a combination of analog and digital circuits, including one or more processors configured with software stored in memory and/or firmware stored in memory that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Thus, those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method implemented by a cooperating base station for coordinated multipoint reception of an uplink signal, the method comprising:
receiving an uplink signal transmitted by a mobile terminal;
demodulating the uplink signal to produce soft output values that each indicate the value of a corresponding information symbol in the uplink signal and the level of certainty in that symbol value; and
selectively sending particular ones of the soft output values to a serving base station over a backhaul communication link based on whether or not the level of certainty indicated by each soft output value exceeds a certainty threshold.

2. The method of claim 1, further comprising dynamically adapting the certainty threshold based on congestion of the backhaul communication link.

3. The method of claim 2, further comprising notifying said serving base station that the certainty threshold has been adapted.

4. The method of claim 1, wherein receiving the uplink signal comprises receiving a composite signal that includes said uplink signal and one or more interfering uplink signals transmitted by one or more other mobile terminals, and wherein the method further comprises suppressing interference in said uplink signal attributable to said interfering uplink signals.

5. The method of claim 1, further comprising sending to said serving base station over the backhaul communication link indexing information that identifies the location in time and frequency of the sent soft output values.

6. The method of claim 5, wherein the indexing information identifies the location of blocked groups of sent soft output values, each blocked group comprising a plurality of sent soft output values that are contiguously located in time and frequency.

7. The method of claim 1, wherein the cooperating base station provides signal coverage for one or more cells, wherein receiving an uplink signal transmitted by a mobile terminal comprises receiving the uplink signal at each of the one or more cells, wherein demodulating the uplink signal comprises demodulating the uplink signal to produce different soft output values for each of the one or more cells, and wherein said selectively sending comprises selectively sending particular ones of the different soft output values based on whether or not the level of certainty indicated by each soft output value exceeds said certainty threshold.

8. A method implemented by a serving base station for coordinated multipoint reception of an uplink signal, the method comprising:
receiving an uplink signal transmitted by a mobile terminal;
demodulating the uplink signal to produce soft output values that each indicate the value of a corresponding information symbol in the uplink signal and the level of certainty in that symbol value;
receiving from a cooperating base station over a backhaul communication link soft output values that have each been selected by the cooperating base station as indicating the value of a corresponding information symbol in the uplink signal with a level of certainty that exceeds a certainty threshold; and
combining respective ones of the produced soft output values and the received soft output values that are associated with the same information symbol.

9. The method of claim 8, further comprising dynamically adapting the certainty threshold based on congestion of the backhaul communication link.

10. The method of claim 8, wherein receiving soft output values comprises receiving different soft output values from different cooperating base stations over different backhaul communication links, the soft output values received from each cooperating base station indicating the value of a corresponding information symbol in the uplink signal with a level of certainty that exceeds a certainty threshold specific to that cooperating base station.

11. The method of claim 10, further comprising jointly setting the certainty thresholds specific to the different cooperating base stations.

12. The method of claim 10, further comprising coordinating joint setting of the certainty thresholds specific to the different cooperating base stations, by requesting that at least one cooperating base station dynamically adapt the certainty threshold specific thereto responsive to receiving notice that another cooperating base station has dynamically adapted the certainty threshold specific thereto.

13. The method of claim 8, further comprising receiving from the cooperating base station over the backhaul communication link indexing information that identifies the location in time and frequency of the received soft output values, and wherein combining respective ones of the produced soft output values and the received soft output values that are associated with the same information symbol comprises combining respective ones of the produced soft output values and the received soft output values that, according to said indexing information, have the same location in time and frequency.

14. The method of claim 13, wherein the indexing information identifies the location of blocked groups of received soft output values, each blocked group comprising a plurality of received soft output values that are contiguously located in time and frequency.

15. A cooperating base station for coordinated multipoint reception of an uplink signal, the cooperating base station comprising:
one or more receive antennas configured to receive an uplink signal transmitted by a mobile terminal;
a demodulator configured to demodulate the uplink signal to produce soft output values that each indicate the value of a corresponding information symbol in the uplink signal and the level of certainty in that symbol value; and
an inter-base station communication interface configured to selectively send particular ones of the soft output values to a serving base station over a backhaul communication link based on whether or not the level of certainty indicated by each soft output value exceeds a certainty threshold.

16. The cooperating base station of claim 15, further comprising a threshold setting circuit configured to dynamically adapt the certainty threshold based on congestion of the backhaul communication link.

17. The cooperating base station of claim 16, wherein the inter-base station communication interface is further configured to notify said serving base station that the certainty threshold has been adapted.

18. The cooperating base station of claim 15, wherein the one or more receive antennas are configured to receive a composite signal that includes said uplink signal and one or more interfering uplink signals transmitted by one or more other mobile terminals, and wherein the base station further comprises an interference suppression circuit configured to suppress interference in said uplink signal attributable to said interfering uplink signals.

19. The cooperating base station of claim 15, wherein the inter-base station communication interface is further configured to send indexing information that identifies the location in time and frequency of the sent soft output values.

20. The cooperating base station of claim 19, wherein the indexing information identifies the location of blocked groups of sent soft output values, each blocked group comprising a plurality of sent soft output values that are contiguously located in time and frequency.

21. The cooperating base station of claim 15, wherein the cooperating base station provides signal coverage for one or more cells, wherein the one or more receive antennas are configured to receive the uplink signal at each of the one or more cells, wherein the demodulator is configured to demodulate the uplink signal to produce different soft output values for each of the one or more cells, and wherein the inter-base station communication interface is configured to selectively send particular ones of the different soft output values based on whether or not the level of certainty indicated by each soft output value exceeds said certainty threshold.

22. A serving base station for coordinated multipoint reception of an uplink signal, the serving base station comprising:
one or more receive antennas configured to receive an uplink signal transmitted by a mobile terminal;
a demodulator configured to demodulate the uplink signal to produce soft output values that each indicate the value of a corresponding information symbol in the uplink signal and the level of certainty in that symbol value;
an inter-base station communication interface configured to receive from a cooperating base station over a backhaul communication link soft output values that have each been selected by the cooperating base station as indicating the value of a corresponding information symbol in the uplink signal with a level of certainty that exceeds a certainty threshold; and
a combining circuit configured to combine respective ones of the produced soft output values and the received soft output values that are associated with the same information symbol.

23. The serving base station of claim 22, further comprising a threshold setting circuit configured to dynamically adapt the certainty threshold based on congestion of the backhaul communication link.

24. The serving base station of claim 22, wherein the inter-base station communication interface is configured to receive different soft output values from different cooperating base stations over different backhaul communication links, the soft output values received from each cooperating base station indicating the value of a corresponding information symbol in the uplink signal with a level of certainty that exceeds a certainty threshold specific to that cooperating base station.

25. The serving base station of claim 24, further comprising a threshold setting circuit configured to jointly set the certainty thresholds specific to the different cooperating base stations.

26. The serving base station of claim 24, further comprising a threshold setting circuit configured to coordinate joint setting of the certainty thresholds specific to the different cooperating base stations, by requesting that at least one cooperating base station dynamically adapt the certainty threshold specific thereto responsive to receiving notice that another cooperating base station has dynamically adapted the certainty threshold specific thereto.

27. The serving base station of claim 22, wherein the inter-base station communication interface is further configured to receive from the cooperating base station over the backhaul communication link indexing information that identifies the location in time and frequency of the received soft output values, and wherein the combining circuit is configured to combine respective ones of the produced soft output values and the received soft output values that, according to said indexing information, have the same location in time and frequency.

28. The serving base station of claim 27, wherein the indexing information identifies the location of blocked groups of received soft output values, each blocked group comprising a plurality of received soft output values that are contiguously located in time and frequency.
